(19) United States
(12) Patent Application Publication
(10) Pub. No.: US 2017/0179641 A1
(43) Pub. Date: Jun. 22, 2017

(54) ELECTRONIC DEVICES AND CONNECTORS

(71) Applicant: Lenovo (Beijing) Limited, Beijing (CN)

(72) Inventors: Wenbo Shi, Beijing (CN); Ping Tian, Beijing (CN)

(21) Appl. No.: 15/087,735

(22) Filed: Mar. 31, 2016

(30) Foreign Application Priority Data
Dec. 16, 2015 (CN) 201510944584.2

(51) Int. Cl. H01R 13/62; H01R 12/73

(52) U.S. Cl. CPC H01R 13/6205; H01R 12/73

(57) ABSTRACT

Disclosed are electronic devices and connectors, including: a first main body, a second main body; the first magnet being arranged at a first end of the first main body and the second magnet being arranged at a second end of the second main body; the first magnet having a magnetic property opposite that of the second magnet; the first main body being pluggably connected to the second main body through the interaction between the first magnet and the second magnet; the first number of spacers is arranged at a preset position of the first magnet, and the first number of spacers is arranged at a preset positions of the second magnet; and the spacers are non-magnetic. Other embodiments, including manufacturing methods, are described and claimed.

### CLAIM FOR PRIORITY

This application claims priority to Chinese Application No. 201510944584.2, filed on Dec. 16, 2015, which is fully incorporated by reference herein.

### FIELD OF THE INVENTION

The present disclosure relates to a connecting structure, particularly to a manufacturing method of electronic devices and connectors.

### BACKGROUND

With the diversification of electronic devices being embraced, detachable electronic devices are widely utilized by users. A detachable electronic device refers to a tablet PC that can be used with/without a keyboard.

At present, the connector between a tablet PC and a keyboard for the detachable electronic device fails to perfectly fix the relative positions of the tablet PC and the keyboard, so the tablet PC is liable to fall from the keyboard connector, severely affecting the user's experience.

### BRIEF SUMMARY

In summary, one aspect provides an electronic device, comprising: a first main body; a second main body; a first magnet being arranged at a first end of the first main body; a second magnet being arranged at a second end of the second main body; the first magnet having a magnetic property opposite that of the second magnet; the first main body being pluggably connected to the second main body through the interaction between the first magnet and the second magnet; one or more spacers that are arranged at a preset position of the first magnet; and one or more spacers that are arranged at a preset position of the second magnet; wherein each of the one or more spacers is non-magnetic.

Another aspect provides a method, comprising: arranging, in first main body of an electronic device, a first magnet at a first end of the first main body; arranging, in a second main body of the electronic device, a second magnet at a second end of the second main body; the first magnet having a magnetic property opposite that of the second magnet; the first main body being pluggably connected to the second main body through the interaction between the first magnet and the second magnet; arranging one or more spacers at preset positions of the first magnet; and arranging one or more spacers at preset positions of the second magnet; wherein each of the one or more spacers is non-magnetic.

A further aspect provides an electronic device, comprising: a processor; a memory operatively coupled to the processor; a first main body that houses the processor and the memory; a second main body; a first magnet being arranged at a first end of the first main body; a second magnet being arranged at a second end of the second main body; the first magnet having a magnetic property opposite that of the second magnet; the first main body being pluggably connected to the second main body through the interaction between the first magnet and the second magnet; one or more spacers that are arranged at a preset position of the first magnet; and one or more spacers that are arranged at a preset position of the second magnet; wherein each of the one or more spacers is non-magnetic.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 shows the assembly diagram of an electronic device;

FIG. 2 shows the assembly diagram of the electronic device in the embodiments;

FIG. 3 shows the diagram of the magnetic blocks segregated by spacers in the embodiments;

FIG. 4 shows the diagram of two magnetic blocks segregated by a spacer in the embodiments;

FIG. 5 shows the process diagram of the connector manufacturing method in the embodiments.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

To solve the foregoing technical problems, embodiments provide a manufacturing method for electronic devices and connectors.

The electronic device in the embodiments comprises: a first main body, a second main body; a first magnet being arranged at a first end of the first main body and a second magnet being arranged at a second end of the second main body; the first magnet having a magnetic property opposite that of the second magnet; the first main body being pluggably connected to the second main body through the interaction between the first magnet and the second magnet. A first number of spacers is/are arranged at a preset position of the first magnet and the first number of spacers is/are arranged at a preset position of the second magnet, and the spacers are non-magnetic.

In the embodiments, the position of spacers in the first magnet has a corresponding relation to the position of spacers in the second magnet.

In the embodiments, the magnets on both sides of the spacers have opposite magnetic properties.

In the embodiments, the first magnet comprises one or more magnetic blocks and the second magnet comprises one or more magnetic blocks.

In the embodiments, wherein the first number of spacers arranged at the preset position of the first magnet and the first number of spacers arranged at the preset position of the second magnet are: the spacers are arranged in the middle of any two magnet blocks for one or more magnet blocks of the first magnet; the spacers are arranged in the middle of any two magnet blocks for one or more magnet blocks of the second magnet.

In a connector manufacturing method of the embodiments, wherein the connector is used in the electronic device, and the electric device comprises: a first main body, a second main body; a first magnet being arranged at a first end of the first main body and a second magnet being arranged at a second end of the second main body; the first magnet having a magnetic property opposite that of the second magnet; the first main body being pluggably connected to the second main body through the interaction between the first magnet and the second magnet; the manufacturing method comprises: a first number of spacers is/are arranged at a preset position of the first magnet; the first number of spacers is/are arranged at a preset position of the second magnet; wherein the spacers are non-magnetic.

In an embodiment, the manufacturing method further comprises: the position of spacers in the first magnet is/are arranged to have a corresponding relation with the position of spacers in the second magnet.

In an embodiment, the manufacturing method further comprises: the magnets on both sides of the spacers are arranged to have opposite magnetic properties.

In an embodiment, the manufacturing method further comprises: arranging one or more magnetic blocks on the first magnet and arranging one or more magnetic blocks on the second magnet.

In the embodiments, wherein the first number of spacers are arranged at the preset position of the first magnet; and the first number of spacers are arranged at the preset position of the second magnet, the spacers are arranged in the middle of any two magnet blocks for one or more magnet blocks of the first magnet; and the spacer is arranged in the middle of any two magnet blocks for two or more magnet blocks of the second magnet.

In a technical solution of an embodiment, the electronic device comprises: a first main body, a second main body; wherein the first main body may be a keyboard and the second main body may be a tablet PC. A first magnet is arranged at a first end of the first main body and a second magnet is arranged at a second end of the second main body; wherein both the first end of the first main body and the second end of the second main body are connection ends. The first magnet has a magnetic property opposite that of the second magnet; and magnets with the opposite magnetic properties have a mutual attraction effect. The first main body is pluggably connected to the second main body through the interaction between the first magnet and the second magnet.

In the embodiments, a first number of spacers is arranged at a preset position of the first magnet and the first number of spacers is arranged at a preset position of the second magnet, and the spacers are non-magnetic. Therefore, the original first magnet/the original second magnet is/are segregated by spacers into a plurality of magnetic blocks; the adjacent magnetic blocks have opposite magnetic properties; when the first main body is connected to the second main body, in accordance with the principle of that the opposite magnetic blocks mutually attract, more magnetic blocks increase the mutual attraction further bettering the attraction between the first and second main bodies, so the structure between the first and second main bodies becomes more stable, promoting the user's experience.

To fully understand the features and technical content in the embodiments, the following section elaborates the embodiments in combination with the attached drawings; meanwhile, the attached drawings are only used for reference but not used to restrict the embodiments.

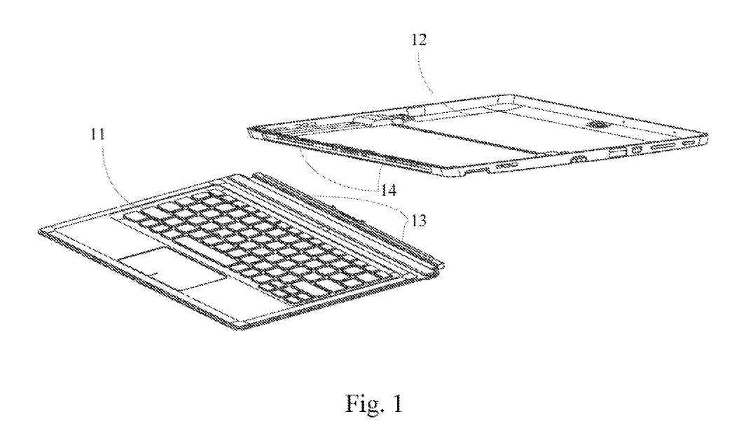

Refer to FIG. 1. FIG. 1 shows the assembly diagram of the electronic device comprising: a first main body 11, a second main body 12; the first magnet 13 is arranged at the first end of the first main body 11 and the second magnet 14 is arranged at the second end of the second main body 12; the first magnet 13 has the magnetic property opposite that of the second magnet 14; the first main body 11 is detachably connected to the second main body 12 through the interaction between the first magnet 13 and the second magnet 14.

In this instance, the electronic device is a detachable appliance generally comprising two main bodies of the first main body 11 and the second main body 12, wherein the first main body 11 is a keyboard (KB) and the second main body 12 is a tablet PC. Without a doubt, depending on varied embodiments of the electronic device, the first main body 11 and the second main body 12 can be further taken as other components; for instance, the first main body 11 and the second main body 12 both are tablet PCs while the electronic device comprises two tablet PCs; in the embodiment mode, the two tablet PCs of the electronic device can be spliced for combined use or separately used.

In this instance, the first magnet 13 is arranged at a first end of the first main body 11 and the second magnet 14 is arranged at a second end of the second main body 12. The first end and the second end are the connecting ends, that is, when the first main body 11 is connected to the second main body 12, the first end of the first main body 11 is connected to the second end of the second main body 12. To connect the first end of the first main body 11 with the second end of the second main body 12, the first magnet 13 is arranged at the first end of the first main body 11 and the second magnet 14 is arranged at the second end of the second main body 12 for this instance.

Specifically, the first magnet 13 and the second magnet 14 can produce the magnetic field, with the feature of attracting ferromagnetic substances such as iron, nickel, cobalt and the like. The first magnet 13 and the second magnet 14 have the polarities; taking the first magnet 13 for instance, the two ends of the bar are the poles with the opposite magnetic properties wherein one is the North pole and the other the South pole, provided that the first magnet 13 is a bar. The North pole has the magnetic property opposite of the South pole. The like magnets repel but the opposite magnets attract among the magnets.

Based on this point, the position of the first magnet 13 shall be corresponding to that of the second magnet 14, while the North pole of the first magnet 13 shall adapt to the South pole position of the second magnet 14 and so shall the South pole of the first magnet 13 to the North pole position of the second magnet 14. Therefore, when the first magnet 13 contacts the second magnet 14, it will produce the attraction leading to connection between the first main body 11 and the second main body 12. When the user wants to detach the first main body 11 from the second main body 12, the user shall pull away the first main body 11 from the second main body 12 with a force equal to or more than the attraction.

In this instance, as the first magnet 13 is installed at the first end of the first main body 11, the number of the first magnets used can be two or more but not only one. Accordingly, the number of the second magnets 14 can be two or more at the second end of the second main body. Only if the positions of the first magnet 13 and the second magnet 14 have a certain corresponding relation leading to the opposite magnetic properties of the first magnet 13 and the second magnet 14, the first magnet 13 contacting the second magnet 14 produces mutual attraction.

For application, the mutual attraction between the keyboard and the tablet PC shall reach 2. 8 kg·m/s² so as to shape a stable connection structure. At present, the magnet at the KB-PC connection just reaches the mutual attraction of 2. 3-2. 4 kg·m/s², with the magnet model of N52. To realize the mutual attraction between the keyboard and the tablet PC of 2. 8 kg·m/s², the embodiments take more spacers made of aluminum or non-magnetic materials between the magnets; after the use of additional spacers, the mutual attraction between magnets can go up to 2. 8 kg·m/s².

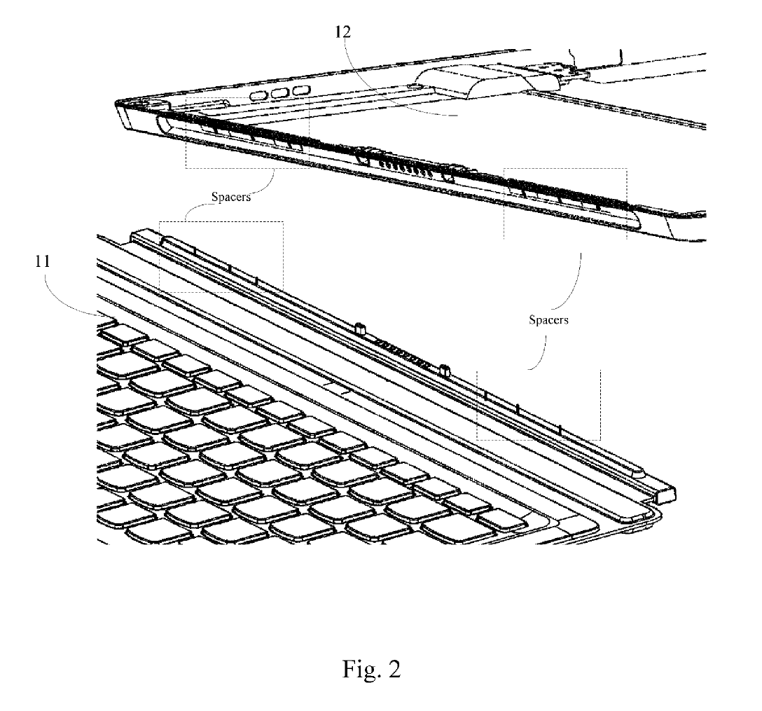

Referring to FIG. 2, FIG. 2 shows the assembly diagram of the electronic device in the embodiments. The electronic device comprises: the first main body 11, the second main body 12; the first magnet 13 is arranged at the first end of the first main body 11 and the second magnet 14 is arranged at the second end of the second main body 12; the first magnet 13 has the magnetic property opposite that of the second magnet 14; the first main body 11 is pluggably connected to the second main body 12 through the interaction between the first magnet 13 and the second magnet 14.

In this instance, the electronic device is a detachable appliance generally comprising two main bodies of the first main body 11 and the second main body 12. The first main body 11 is a keyboard and the second main body 12 is a tablet PC. Depending on varied embodiments of the electronic device, the first main body 11 and the second main body 12 can be further taken as other components. For instance, the first main body 11 and the second main body 12 both are tablet PCs while the electronic device comprises two tablet PCs; in the embodiment mode, the two tablet PCs of the electronic device can be spliced for combined use or separately used.

In this instance, the first end of the first main body 11 is equipped with the first magnet 13 and the second end of the second main body 12 described is equipped with a second magnet 14. The first end and the second end are connections, that is, when the first main body 11 is connected to the second main body 12, the first end of the first main body 11 is connected to the second end of the second main body 12. To connect the first end of the first main body 11 with the second end of the second main body 12, the first magnet 13 is arranged at the first end of the first main body 11 and the second magnet 14 is arranged at the second end of the second main body 12 for this instance.

Specifically, the first magnet 13 and the second magnet 14 can produce the magnetic field, with the feature of attracting ferromagnetic substances such as iron, nickel, cobalt and the like. The first magnet 13 and the second magnet 14 have the polarities. Taking the first magnet 13 for instance, the two ends of the bar are the poles with the opposite magnetic properties wherein one is the North pole and the other the South pole, provided that the first magnet 13 is a bar. The North pole has the magnetic property opposite of the South pole. The like magnets repel but the opposite magnets attract among the magnets.

Based on this point, the position of the first magnet 13 shall be corresponding to that of the second magnet 14, while the North pole of the first magnet 13 shall adapt to the South pole position of the second magnet 14 and so shall the South pole of the first magnet 13 to the North pole position of the second magnet 14. Therefore, when the first magnet 13 contacts the second magnet 14, it will produce the attraction leading to connection between the first main body 11 and the second main body 12. When the user wants to detach the first main body 11 from the second main body 12, the user shall pull away the first main body 11 from the second main body 12 with a force equal to or more than the attraction.

In this instance, as the first magnet 13 is installed at the first end of the first main body 11, the number of the first magnets used can be two or more but not only one. Accordingly, the number of the second magnets 14 can be two or more at the second end of the second main body. Only if the positions of the first magnet 13 and the second magnet 14 have a certain corresponding relation leading to the opposite magnetic properties of the first magnet 13 and the second magnet 14, the first magnet 13 contacting the second magnet 14 produces mutual attraction.

In this instance, the first magnet 13 comprises one or more magnetic blocks and the second magnet 14 comprises one or more magnetic blocks. For instance, the first magnet 13 comprises three magnetic blocks, composed of three magnetic blocks, wherein each magnetic block is an independent magnet. In other words, each magnetic block comprises the North and South poles; the three magnetic blocks are spliced together with the North poles connected to the South poles of the adjacent magnetic blocks so as to shape the big block of the first magnet 13. For the first magnet 13 on the whole, the first magnet 13 has one North pole and one South pole. Similarly, the second magnet 14 comprises three magnetic blocks, composed of three magnetic blocks, wherein each magnetic block is an independent magnet. In other words, each magnetic block comprises the North and South poles. The three magnetic blocks are spliced together with the North poles connected to the South poles of the adjacent magnetic blocks so as to shape the big block of the second magnet 14. For the second magnet 14 as a whole, the second magnet 14 has one North pole and one South pole.

In this instance, the first number of spacers is arranged at the preset position of the first magnet 13 and the first number of spacers is arranged at the preset position of the second magnet 14, while the spacers are non-magnetic. As the spacers are non-magnetic, the magnets on the both sides of the spacer have the opposite magnetic properties.

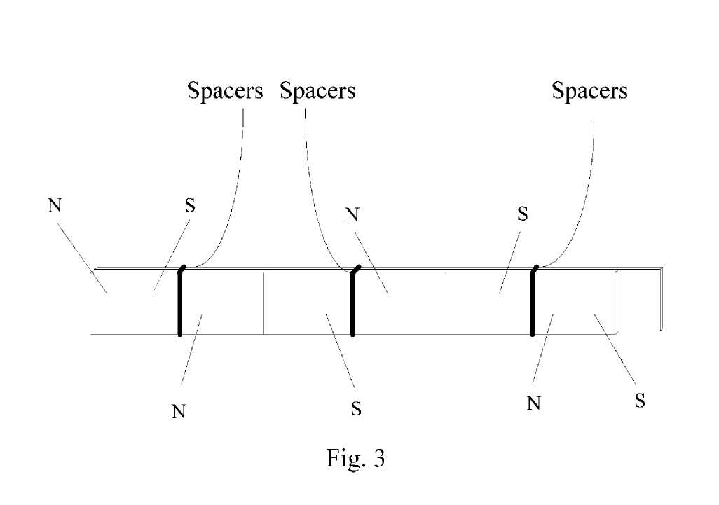

Specifically, referring to FIG. 3, FIG. 3 shows the diagram of the magnetic blocks segregated by spacers in the embodiments. The first magnet 13 is segregated by three spacers into four independent magnetic blocks which has one North pole and one South pole. As the first magnet is segregated, the number of its magnetic poles increases to improve the mutual attraction between the magnets.

In an implementation mode, the spacers are arranged in the middle of any two magnetic blocks for one or more blocks of the first magnet; and the spacers are arranged in the middle of any two magnetic blocks for one or more blocks of the second magnet. The arrangement is easy to fabricate and realize.

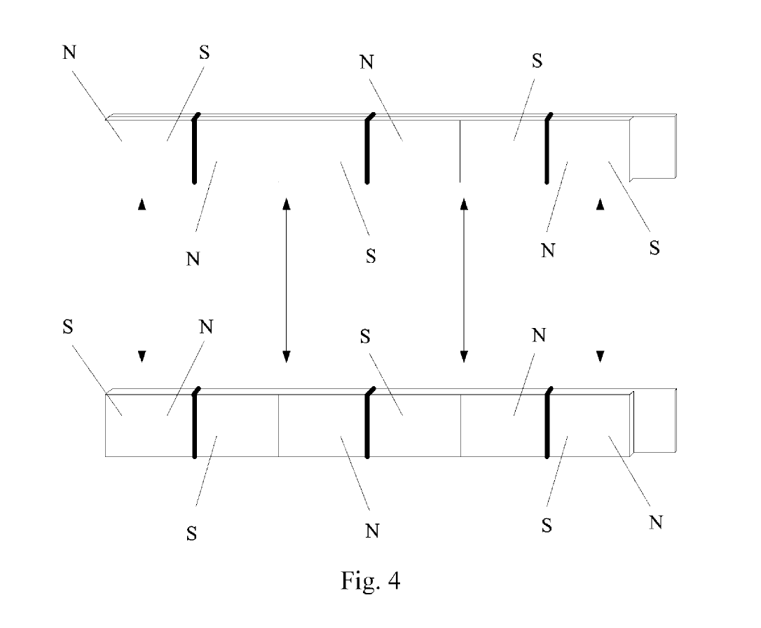

Referring to FIG. 4, FIG. 4 shows the diagram of two magnetic blocks segregated by a spacer in the embodiments. The first magnet 13 is segregated by three spacers as is the second magnet 14, while the spacer positions have the corresponding relation; the first magnet 13 is segregated by three spacers into 4 independent blocks with its own North and South poles per block. Accordingly, after the first magnet 13 mutually contacts the second magnet 14, the mutual attraction between the North and South poles results in firm connection between the first magnet 13 and the second magnet 14 under attraction; meanwhile, due to an increase in the number of magnetic poles, the attraction is further enhanced so that the connection structure is more stable.

To realize the electronic device herein, the embodiments further provide a manufacturing method of connectors applied in the electronic device, the electronic device comprising: the first main body, the second main body; the first magnet being arranged at the first end of the first main body and the second magnet being arranged at the second end of the second main body; the first magnet having the magnetic property opposite that of the second magnet; the first main body being detachably connected to the second main body through the interaction between the first magnet and the second magnet.

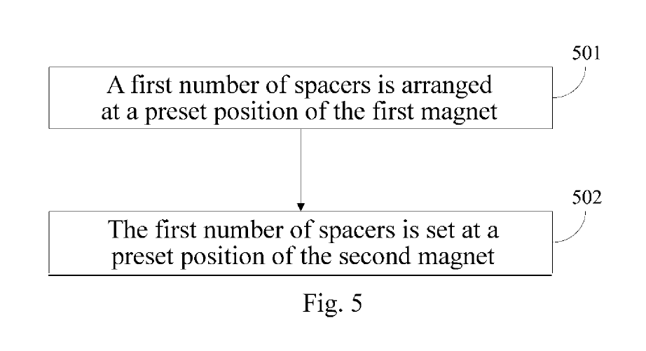

Referring to FIG. 5, FIG. 5 shows the process diagram of the connector manufacturing method in the embodiments of the present invention; as shown in FIG. 5, the connector manufacturing method includes the following steps.

In step 501, a first number of spacers is arranged at a preset position of the first magnet. In the embodiments, the spacers are non-magnetic. In step 502, the first number of spacers is arranged at a preset position of the second magnet.

In the embodiments, the spacers are non-magnetic.

In an embodiment, the manufacturing method further comprises: the position of spacers in the first magnet are arranged to have a corresponding relation with the position of spacers in the second magnet.

In an embodiment, the manufacturing method further comprises: the magnets on both sides of the spacers are arranged to have opposite magnetic properties.

In an embodiment, the manufacturing method further comprises: arranging one or more magnetic blocks on the first magnet and arranging one or more magnetic blocks on the second magnet.

In the embodiments, wherein the first number of spacers are arranged at the preset position of the first magnet, the first number of spacers are arranged at the preset position of the second magnet, comprising: the spacers being arranged in the middle of any two magnet blocks for one or more magnet blocks of the first magnet; the spacers being arranged in the middle of any two magnet blocks for one or more magnet blocks of the second magnet.

Those skilled in the art shall understand that the connector manufacturing method shown in FIG. 5 can be comprehended with the relevant description of the foregoing electronic device for reference.

The technical solutions in the embodiments can be combined in the case of no conflicts.

The embodiments are only schematic. For example: a plurality of units or components can be combined or integrated into another system, or certain characteristics can be omitted or not exercised. Additionally, coupling, direct coupling, or communication connections among the component parts as shown or discussed may be implemented through some interface(s), and indirect coupling or communication connections of devices or units may be in an electrical, mechanical, or other form.

The units described as detachable components may or may not be separated physically and the units described as the unit displays may or may not be separated physically; in other words, the units can be located in a place or distributed at a plurality of network units; and based on the actual demands, the units thereof in part or in whole can be selected for the purpose of the embodiments.

In addition, all functional units in the embodiments can be fully integrated into a second processing unit, or each functional unit is separately used as a unit or two or more units are integrated into one unit; moreover, the integrated unit can be realized in the hardware manner or in the manner of hardware plus a software functional unit.

The above example embodiments are only some particular example implementations of the present disclosure, and the protection scope of the present disclosure is not limited thereto. Variations or alterations that are within the technical scope as disclosed in the present disclosure and may be readily conceived by those skilled in the art fall within the protection scope of the present disclosure.

What is claimed is:

1. An electronic device, comprising:
a first main body;
a second main body;
a first magnet being arranged at a first end of the first main body;
a second magnet being arranged at a second end of the second main body;
the first magnet having a magnetic property opposite that of the second magnet;
the first main body being pluggably connected to the second main body through the interaction between the first magnet and the second magnet;
one or more spacers that are arranged at a preset position of the first magnet; and
one or more spacers that are arranged at a preset position of the second magnet;
wherein each of the one or more spacers is non-magnetic.

2. The electronic device according to claim 1, wherein the position of the one or more spacers in the first magnet has a corresponding relation to the position of the one or more spacers in the second magnet.

3. The electronic device according to claim 1, wherein magnets formed on both sides of a spacer of the one or more spacers have opposite magnetic properties.

4. The electronic device according to claim 1, wherein the first magnet comprises one or more magnetic blocks and the second magnet comprises one or more magnetic blocks.

5. The electronic device according to claim 4, wherein the one or more spacers arranged at the preset position of the first magnet and the one or more spacers arranged at the preset position of the second magnet comprise:
at least one spacer arranged in the middle of any two magnet blocks for one or more magnet blocks of the first magnet;
at least one spacer arranged in the middle of any two magnet blocks for one or more magnet blocks of the second magnet.

6. A method, comprising:
arranging, in first main body of an electronic device, a first magnet at a first end of the first main body;
arranging, in a second main body of the electronic device, a second magnet at a second end of the second main body;
the first magnet having a magnetic property opposite that of the second magnet;
the first main body being pluggably connected to the second main body through the interaction between the first magnet and the second magnet;
arranging one or more spacers at preset positions of the first magnet; and
arranging one or more spacers at preset positions of the second magnet;
wherein each of the one or more spacers is non-magnetic.

7. The method according to claim 6, further comprising:
arranging the one or more spacers of the first magnet to have a corresponding relation with a position of the one or more spacers in the second magnet.

8. The method according to claim 6, wherein magnetic blocks formed on both sides of a spacer of the one or more spacers have opposite magnetic properties.

9. The method according to claim 6, wherein one or more of the magnetic blocks on the first magnet are formed and one or more magnetic blocks on the second magnet are formed.

10. The method according to claim 9, wherein the one or more spacers of the first magnet are arranged at preset positions to form two or more magnetic blocks of the first magnet; and the one or more spacers of the second magnet are arranged at preset positions to form two or more magnetic blocks.

11. The method of claim 10, wherein:
at least one spacer of the first magnet is arranged in the middle of any two magnetic blocks; and
at least one spacer of the second magnet is arranged in the middle of any two magnetic blocks.

12. An electronic device, comprising:
a processor;
a memory operatively coupled to the processor;
a first main body that houses the processor and the memory;
a second main body;
a first magnet being arranged at a first end of the first main body;
a second magnet being arranged at a second end of the second main body;
the first magnet having a magnetic property opposite that of the second magnet;
the first main body being pluggably connected to the second main body through the interaction between the first magnet and the second magnet;
one or more spacers that are arranged at a preset position of the first magnet; and
one or more spacers that are arranged at a preset position of the second magnet;
wherein each of the one or more spacers is non-magnetic.

13. The electronic device according to claim 12, wherein the position of the one or more spacers in the first magnet has a corresponding relation to the position of the one or more spacers in the second magnet.

14. The electronic device according to claim 12, wherein magnets formed on both sides of a spacer of the one or more spacers have opposite magnetic properties.

15. The electronic device according to claim 12, wherein the first magnet comprises one or more magnetic blocks and the second magnet comprises one or more magnetic blocks.

16. The electronic device according to claim 15, wherein the one or more spacers arranged at the preset position of the first magnet and the one or more spacers arranged at the preset position of the second magnet comprise:
at least one spacer arranged in the middle of any two magnet blocks for one or more magnet blocks of the first magnet;
at least one spacer arranged in the middle of any two magnet blocks for one or more magnet blocks of the second magnet.

17. The electronic device according to claim 12, wherein the first magnet and the second magnet are divided into a plurality of magnetic blocks by the one or more spacers of the first magnet and the second magnet.

18. The electronic device according to claim 17, wherein an attractive force between the first magnet and the second magnet is increased by the one or more spacers of the first magnet and the one or more spacers of the second magnet as compared to the first magnet having no spacers and the second magnet having no spacers.

19. The electronic device according to claim 18, wherein the attractive force is increased as a function of the number of spacers.

20. The electronic device of claim 12, wherein the second main body comprises a tablet computing device having a display screen.
